(19) United States
(12) Patent Application Publication
(10) Pub. No.: US 2016/0019180 A1
(43) Pub. Date: Jan. 21, 2016

(54) METHOD AND DEVICE FOR FILTERING TRANSACTIONS FOR AN ON-CHIP SYSTEM

(71) Applicant: SAGEM DEFENSE SECURITE, Boulogne-Billancourt (FR)

(72) Inventors: Celine Liu, Boulogne Billancourt (FR); Nicolas Charrier, Boulogne Billancourt (FR); Nicolas Marti, Boulogne Billancourt (FR)

(21) Appl. No.: 14/772,059

(22) PCT Filed: Mar. 5, 2014
(86) PCT No.: PCT/EP2014/054273

§ 371 Date: Sep. 1, 2015

(30) Foreign Application Priority Data
Mar. 6, 2013 (FR) 1352016

(51) Int. Cl. G06F 13/42; G06F 13/40; G06F 13/364

(52) U.S. Cl. CPC G06F 13/4282; G06F 13/364; G06F 13/4022

(57) ABSTRACT

The invention in particular concerns a method for filtering access to an on-chip system comprising at least one master module, at least one slave module and a bus, the bus comprising at least one slave port, at least one master port and means for interconnection between at least one of the slave ports and at least one of the master ports, the method being characterised in that it comprises the following steps implemented when an access request is routed from a master module connected to a slave port to a slave module connected to a master port: intercepting an item of source information on the link between the master port and the slave module before the slave module receives the request, searching for the item of source information in at least one access control list controlling access to the slave module, blocking the request such that the slave module is unaware of the requested access if the item of source information is not found in the at least one access control list.

### FIELD OF THE INVENTION

The invention relates to the field of systems on chip often designated by the term system on chip or its abbreviation SoC.

The invention relates more particularly to systems on chip in which the interconnections between modules are made by internal computer buses and associated routing control means.

### PRIOR ART

A system on chip (Soc) is a complete system embedded on a chip which can comprise one or more processors, memory, interface peripherals and/or other components necessary for performing a complex function. A Soc can also designate a mixed system comprising digital elements, analog elements, and analog/digital converters.

SoCs of FPGA type generally have hierarchical architecture: “master” modules execute access reading or writing requests to modules called “slaves”. For example, typical masters are processors or controllers of direct access to memory (DMA); typical slaves are storage memories or network peripherals.

The interconnections between masters and slaves are typically the responsibility of internal computer buses compatible with one or more communication protocols.

For example, the AMBA protocol (“Advanced Microcontroller Bus Architecture”) is a communication standard widely used today especially on SoC multiprocessors. This protocol declines into several versions and variants, including for example AHB (“Advanced High-performance Bus”) and AXI (“Advanced eXtensible Interface”) which are more particularly dedicated to high-rate transfer of data by bursts.

FIG. 1 illustrates a computer bus B ensuring interconnections between k master modules Mi,iε[[1,k]] and n slave modules Sj,jε[[1,n]]. This bus comprises k slave ports PSi,iε[[1, k]] on each of which is connected a master module, and n master ports PMj,jε[[1,n]], on each of which is connected to a slave module. So, the bus is seen as a slave by each master module, and seen as a master by each slave module. Data can be transmitted according to a specific communication protocol over each link between a port of the bus and a module.

The bus B comprises internal routing means, for example one or more stages of switches shown in FIG. 1 by arrows in dotted lines. These means ensure routing of communications between a master and a slave, such as for example read or write access requests sent by a master to a slave.

The bus B illustrated in FIG. 1 makes all possible interconnections between one of the k masters and one of the n slaves, or k*n interconnections. In this way, the slave S1 can for example receive requests sent by several masters, and have shared access between the latter. The bus B also authorises access to masters at the same time if they access separate slaves by way of separate internal switches.

The majority of computer buses makes a large number of physical interconnections between slave ports and master ports, if not all those technically possible, as in the case of the bus B.

However, the majority of Socs including computer buses sold commercially does not exert fine control of physical interconnections between the masters and the slaves.

Yet, in some architectures, it is preferred to have the possibility to prohibit communications permanently or temporarily on some interconnections for reasons of security and/or efficacy. This is the case for example of systems on chip of a level of criticality A according to the RTCA DO-254 standard, on which physically permitted connections can have catastrophic consequences, such as for example systems on chip dedicated to aircraft command control.

By way of example, the NIC-301 connector for ARM architecture is a black box which offers no possibility of prohibiting some interconnections between its slave ports and its master ports.

Also, computer buses can be subject to failures generating erroneous referrals which can cause slowdowns to access to a slave or even complete blockage. These malfunctions can for example be caused by elements of transistor type, sensitive to transitory effects (Single Event Upset).

These delays can prove especially annoying in the event where high-priority access must be made very quickly. This the case for example for systems on chip of a level of criticality A according to the RTCA DO-254 standard, on which breakdowns or even transaction slowdowns can have catastrophic consequences, such as for example, systems on chip dedicated to aircraft command control.

### PRESENTATION OF THE INVENTION

The aim of the invention is to exert control on communications between master modules and slave modules of a system on chip, which transit via a computer bus so as to prevent unauthorised communications.

For this to happen, the invention relates especially to an access filtering method in a system on chip comprising at least one master module, at least one slave module and a bus, the bus comprising at least one slave port, at least one master port and interconnection means between at least one of the slave ports and at least one of the master ports, the method being characterized in that it comprises the following steps conducted when an access request is routed from a master module connected to a slave port to a slave module connected to a master port:
interception on the link between the master port and the slave module of source information before the slave module receives the request,
search of the source information in at least one access control list to the slave module, and
blockage of the request such that the slave module ignores the requested access, if the source information is not found in the at least one access control list.

The interception step of the proposed filtering method is performed downstream of the interconnection bus, closest to the slave module. In this way, prohibited access of multiple origins can be avoided: not only prohibited access caused by a poorly configured request by the master sending module, but also access prohibited caused by internal routing errors to the interconnection bus.

The invention therefore enables fine control of interconnections on any computer bus AMBA sold commercially, or any other bus adapted to make interconnections between master modules and slave modules. The adaptation of a computer bus for specific interconnection needs of a system on chip is therefore not necessary, and reduces design and manufacturing costs of the system on chip.

The proposed method can advantageously be completed by the following characteristics taken individually or combined when technically possible.

The source information can comprise a unique identifier of the slave port via which the request transits.

This unique identifier of the slave port identifies the routing undertaken by the bus from a slave port to a master port, and therefore authorises filtering per route followed in the interconnection bus.

The source information can also comprise an identifier of the master module having sent the request. This securely identifies the source of the request, and therefore operates filtering per master module.

The source information can be formed by concatenation of the identifier of the master module and of the unique identifier of the slave port so as to offer finer filtering according to two criteria (module source and route followed), and compact transport of these two criteria in the same source information, transported by a single request.

The identifier of the master module can also be associated with an emission context of the request by the master module. The effect of this is to offer a non-binary, and therefore more flexible, filtering criterion of requests emanating from the same master module. Some requests emanating from this master module can be filtered and some others emanating from the same master module cannot be filtered, as a function of the associated emission context.

The search step can be conducted in two access control lists to the slave module, one containing authorised read source information and the other containing authorised write source information.

The method according to the invention can be executed advantageously in architectures comprising a bus of AMBA type.

In an embodiment in which the communication protocol between the master port and the slave module is the AXI protocol, the blockage step can comprises zero positioning of a signal sent to the slave module, the signal being AWVALID if the request is a write request, or ARVALID if the request is a read request.

In another embodiment in which the communication protocol between the master port and the slave module is the AHB or AHB-lite protocol, the blockage step can comprise zero positioning of a HSEL signal sent to the slave module).

In another embodiment in which the communication protocol between the master port and the slave module is the APB protocol, the blockage step can comprise zero positioning of a PSEL signal sent to the slave module.

The method according to the invention can also comprise an extra sending step of an exception message to an interruption controller after blockage of the request. Such a message warns this controller of the occurrence of a blockage, such that the latter can method the blockage the most adequately.

An access control device to one slave module by means of an interconnection bus is also proposed, comprising storage means and data-processing means for executing the above filtering method.

An assembly is further proposed, comprising at least one master module, at least one slave module, a bus ensuring interconnection between at least one of the master modules and at least one of the slave modules, and at least one access control device such as mentioned above and connected to a master port of the bus and to one of the slave modules.

A system on chip comprising at least one assembly is finally proposed, according to the claim as mentioned above.

### DESCRIPTION OF FIGURES

Other characteristics, aims and advantages of the invention will emerge from the following description which is purely illustrative and non-limiting, and which must be viewed with respect to the appended drawings, in which:

FIG. 1 schematically illustrates a known system on chip.

FIG. 2 illustrates a sequence of signals of the AXI protocol sent during reading.

FIG. 3 illustrates a sequence of signals of the AXI protocol sent during writing.

FIG. 4 illustrates a diagram of steps of the filtering method according to the invention.

FIG. 5 schematically illustrates a system on chip protected by a filtering device according to the invention.

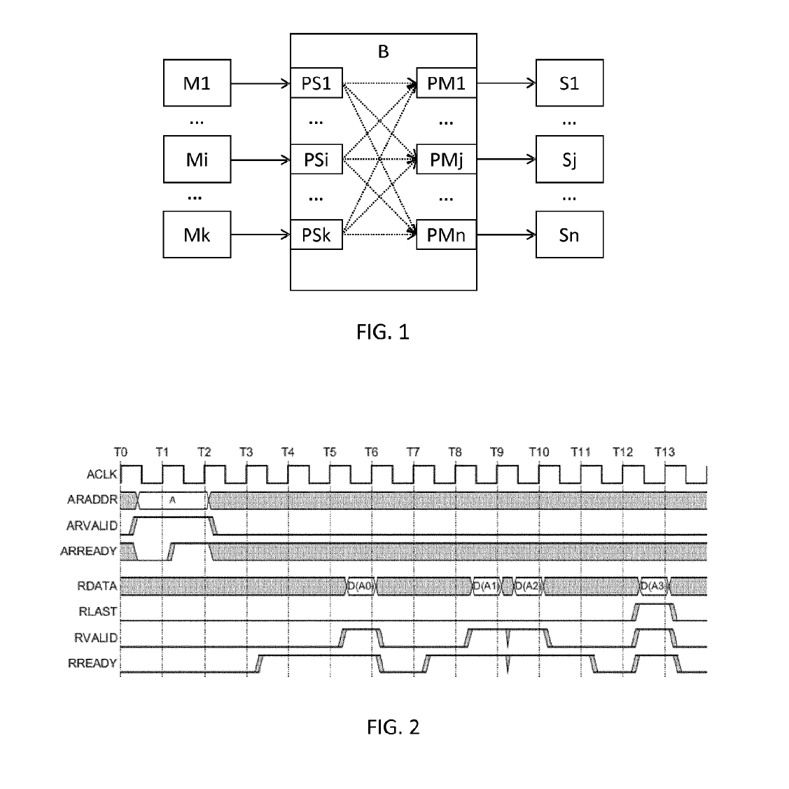

Similar elements bear identical reference numerals in all figures.

### DETAILED DESCRIPTION OF THE INVENTION

The AXI protocol defines a unique interface for describing communications between a master module and a slave module, a master module and the slave port of a bus, or the master port of a bus and a slave module.

This interface comprises five channels: two channels dedicated to reading (one control channel and one data channel) and three to writing (one control channel, one data channel and one response channel).

The channels each send out a set of signals unidirectionally. For example, the reading control channel sends out request signals from the master to the slave, while the reading data channel returns data carrier signals from the slave to the master.

The signals must be positioned according to an ordered sequence for executing data transfer. FIG. 2 illustrates for example a positioning sequence of signals for reading a data burst.

### Example of Read Transaction

FIG. 2 illustrates for example a positioning sequence of signals for reading by bursts according to AXI protocol, completed in four data transfers. The functions of used signals are listed in the table below:

| Signal | Source | Description |
|---|---|---|
| ACLK | Clock | Reference clock. |
| | source | |
| ARADDR | Master | Read address. |
| ARVALID | Master | Positioned at 1 during transmission by the master |
| | | of a valid read address, if not at 0. |
| ARREADY | Slave | Indicates if the slave is ready (1) or not (0) to |
| | | accept a read address and associated control |
| | | signals. |
| RREADY | Master | Indicates if the master is ready (1) or not (0) to |
| | | receive read data. |
| RDATA | Slave | Read data. |
| RVALID | Slave | Indicates if the expected read data are ready for |
| | | transfer (1) or not (0) |
| RLAST | Slave | Indicates the most recent transfer of read data. |

In reference to FIG. 2, a read transaction according to AXI protocol comprises the following steps.

The signal ACLK is synchronised on the clock of a master. The master sends out the signal ARADDR containing a read address A of the slave to which it wants to give read access. At the same time, the master positions the signal ARVALID at one to signify the validity of the address A to the receiving slave.

The slave confirms the availability of the address A by positioning the signal ARREADY.

The master then positions the signal RREADY at one to signify to the slave that it is ready to read data.

The read data are then transmitted by the slave to the signal RDATA.

FIG. 2 illustrates reading of four transfers D(A0), D(A1), D(A2) and D(A3). During each transfer, the signal RVALID is positioned at one by the slave to signify the validity of data to the master. To indicate to the master that a transfer is the last one, the signal RLAST is positioned at one at the start of the final transfer D(A3).

The reading illustrated in FIG. 2 is done in thirteen clock strokes (between the clock strokes T0 and T13).

### Example of Write Transaction

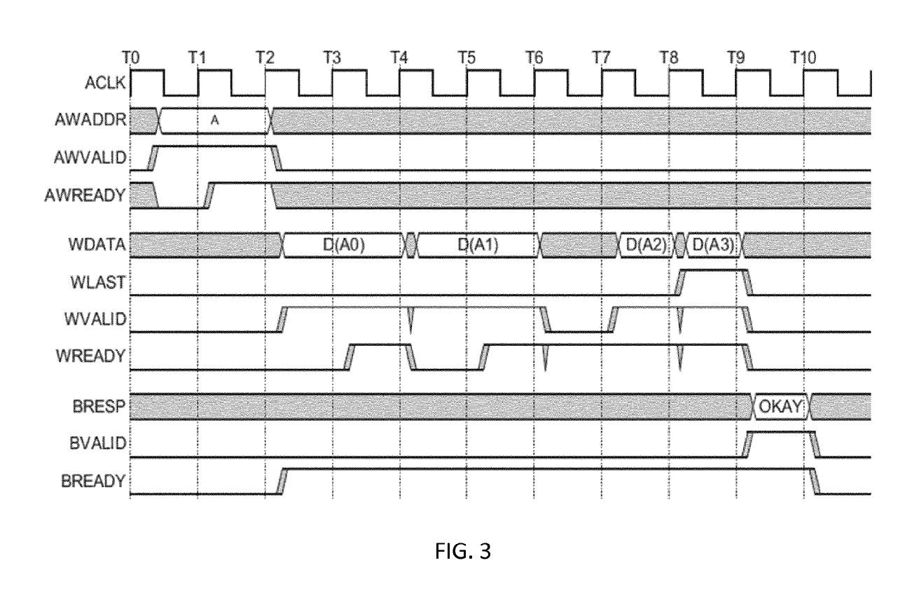

FIG. 3 shows an example of a sequence of positioning signals for writing according to the AXI protocol, and also completed in four data transfers. The functions of these signals are listed in the table below:

| Signal | Source | Description |
|---|---|---|
| ACLK | Clock | Reference clock. |
| | source | |
| AWADDR | Master | Write address. |
| AWVALID | Master | Positioned at 1 during transmission by the master |
| | | of a valid write address, if not at 0. |
| AWREADY | Slave | Indicates if the slave is ready (1) or not (0) to |
| | | accept a write address and associated control |
| | | signals. |
| WREADY | Slave | Indicates if the slave is ready (1) or not (0) to |
| | | receive write data. |
| WDATA | Master | Write data. |
| WVALID | Master | Indicates if the write data are ready for |
| | | transfer (1) or not (0) to the slave. |
| BRESP | Slave | Write result (2 bits): OKAY, EXOKAY, |
| | | SLVERR, or DECERR. |
| BVALID | Slave | Positioned at 1 during transmission by the slave |
| | | of a valid write result, if not at 0. |
| WLAST | Master | Indicates the last transfer of write data. |
| BREADY | Master | Positioned at 1 to signify that the master is ready |
| | | to receive a write result, if not at 0. |

In reference to FIG. 3, a read transaction according to the AXI protocol comprises the following steps.

The signal ACLK is synchronised to a clock source. A master sends the AWADDR signal containing a write address A of the slave to which it wants access. At the same time, the master positions the signal AWVALID at one to signify to the receiving slave the validity of the address A.

The slave confirms the availability of the address A by positioning the AWREADY signal at one.

The slave then positions the WREADY signal at one to signify to the master that it is ready to receive data to be written.

The write data are then transmitted by the master to the WDATA signal. FIG. 3 illustrates a burst of four transfers D(A0), D(A1), D(A2) and D(A3). At the start of the first transfer, the BREADY signal is positioned at one by the master to indicate that it is ready to receive a write result which will be sent on completion of the sequence. During each transfer, the WVALID signal is positioned at one by the master to signify to the slave the validity of data to be written. To indicate to the slave that a transfer D(A3) is the last, the WLAST signal is positioned at one at the start of the last transfer.

To confirm writing to the master, the slave then positions the BRESP signal at the OKAY value. This positioning is accompanied by positioning of the BVALID signal at one throughout transmission of the OKAY value. The master finally repositions the BREADY signal to zero once this value is received.

The writing illustrated in FIG. 3 is done in ten clock strokes (between the clock strokes T0 and T10).

Other protocols of the AMBA (AHB, AHB-Lite) family follow the same general principle with different signals.

Each interface between a bus complying with the AMBA standard and a slave module or master can implement one of the protocols of the AMBA family.

In reference to FIG. 5, let this be a system on chip comprising at least one master module M1, . . . , Mi, . . . , Mk, at least one slave module S1, . . . , Sj, . . . , Sn and a bus B.

The bus B comprises interconnection means for communicating at least one slave module Sj with at least one module M1, . . . , Mi, . . . , Mk.

The communication route between a master module Mi and a slave module Sj comprises at least two communication links: a first communication link between the master module Mi and a slave port PSi of the bus B, and a second communication link between a master port PMj of the bus B and the slave module Sj. The signals sent by the secondary master module Mi transit via the slave port PSi, then are routed by the bus B to the master port PMj then are sent to the slave module Sj connected to this master port PMj. The signals sent by the slave module Sj to the secondary master Mi follow the same route in reverse direction.

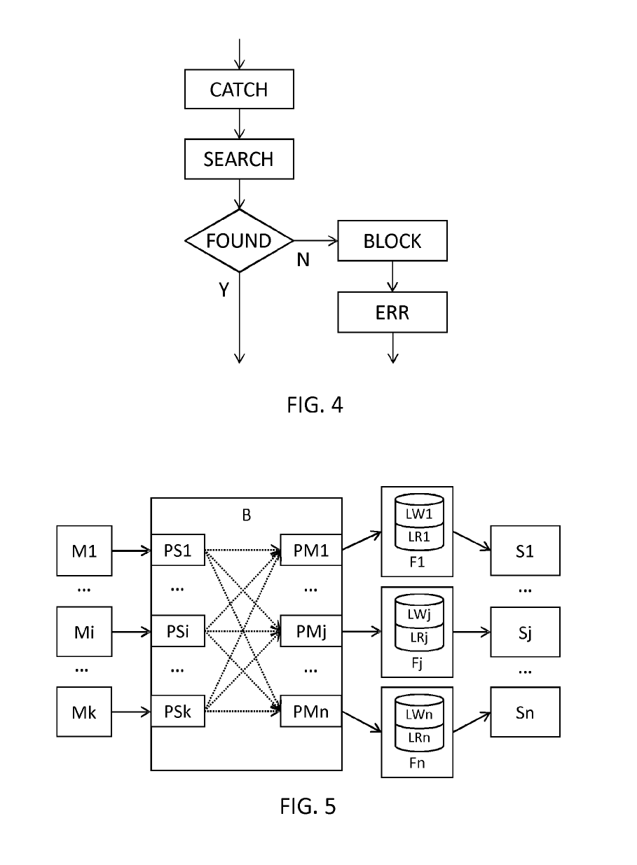

The filtering method according to the invention will now be described in reference to the diagram of FIG. 4.

In the system described previously and illustrated in FIG. 5, a request is asked for by a master module Mi and routed to a slave module Sj.

A first step “CATCH” consists of intercepting source information INFO at a point of the system before the slave module Sj receives the request.

Source information INFO means information transported by one or more signals of the communication protocol used, uniquely defining at least one portion of route traversed between the master module source and the interception point.

In a second step “SEARCH”, the source information INFO is searched for in at least one access control list Lj to the slave module Sj. This list Lj previously registered contains source information authorised by the system for giving access to the slave module Sj.

In a third test step “FOUND”, verification is made to see if the information is found in this list Lj:
If the source information INFO is not found (“N”), it is considered that the master module Mi is not authorised to access the slave Sj. The request is blocked “BLOCK” so that the slave module Sj cannot acknowledge the request.
If not (“Y”), the request is transmitted to the slave module Sj.

The interception step “CATCH” is preferably conducted as closely as possible to the slave module Sj so as to obtain source information defining the longest possible route portion, preferably on the link between the master port PMj of the bus B via which the request has transited and the slave module Sj.

The source information INFO can comprise a unique port identifier IDPSi previously assigned to the slave port PSi via which the request has transited. In this case, the source information INFO determines the routing taken by the bus from a slave port to a master port. Routing errors caused by at least one of the traversed buses, and errors caused by a master module requesting undue access to a slave module can therefore be detected.

The source information INFO can also comprise an identifier IDMi which identifies the master module Mi having sent the request. This surely identifies the source of the request.

The AXI protocol can be used on the communication link between the master port PMj and the slave module Sj.

The identifier of the master module can be detected by interception of ensuing signals sent by the master module to the slave module:
the AWID signal on the control channel, in the case of a write request;
the WID signal on the data channel, in the case of a write request;
the ARID signal on the control channel, in the case of a read request.

A master can be encouraged to send different types of requests to the same slave: for example, a processor can send several read requests to one memory peripheral, each request being managed in a specific process. Consequently, improvement of the method can consist of associating the IDMi identifier with an emission context of the request sent by a master module Mi. This improvement makes additional discrimination among the requests coming from the same master module. This context can typically be a unique process identifier.

In an embodiment, source information INFO corresponds to the concatenation of the unique identifier IDPSi of the slave port Psi and of the identifier IDMi characteristic of a type of request sent by the master module Mi. This structure enables simultaneous processing of these two identifiers in the “CATCH” interception and “SEARCH” search steps and therefore shortens the processing period of the method.

The search step “SEARCH” can also be performed in two separate access LWj and LRj lists, the LRj list containing source information authorised to make read requests on the slave module Sj and the LWj list containing source information authorised to make write requests on the slave module Sj. This optimisation especially decreases the duration of the search step. The blockage step “BLOCK” can be conducted by modifying in flight the positioning of at least one of the signals received from the master port PMj of the last bus traversed and transmitting these repositioned signals to the slave module Sj such that the latter ignores the request initially sent by the master module Mi. Of course, if the request is found in the corresponding list, all the signals received from the master port are sent to the slave module without modification.

The repositioned signals depend on the communication protocol selected between the bus B and the slave module Sj.

In the case of the AXI protocol, the signal AWVALID can be repositioned to zero if the request is a write request. This zero value increases has the slave module Sj believe that no address is available on the write control channel, and not know of the request.

In the same way, the ARVALID signal can be repositioned to zero if the request is a write request. This value has the slave module Sj believe that no address is available on the read control channel, and not know of the request.

The same repositioning principle is applicable to other protocols:
In the case of the AHB protocol or the AHB-lite protocol, the HSEL signal can be repositioned to zero.
In the case of the APB protocol, the PSEL signal can be repositioned to zero.

As is preferred, the method comprises an additional sending step “ERR” of an exception message EX to an interruption controller (not shown) of the system on chip, after the blockage step “BLOCK”. This controller can for example be integrated into the master Si having been the origin of the blocked request, such that the latter can process the blockage the most adequately.

The invention also relates to a filter Fj,jε[[1, n]] which executes the method described previously. This filter can optionally be integrated into a bus, form part of a slave module, or be in the form of an autonomous module placed on the link between a master port of a bus and a slave module, as illustrated in FIG. 4.

The filter comprises storage means for storage of at least one access control list Lj,jε[[1,n]], for example one or more memories, for example of flash type, triplicate RAM or EEPROM. The storage size of these means is proportional to the encoding length of source information, and of the amount of authorised source information. The authorised source information contained in the stored lists can be written a single time before being put into service of the system on chip, or can be reconfigured dynamically.

The filter also comprises processing means for performing the different steps of the filtering method described.

The invention also relates to an assembly illustrated in FIG. 4 comprising at least one master module Mi,iε[[1,k]], at least one slave module Sj,jε[[1,n]], a bus B complying with the AMBA standard ensuring interconnection between at least one of the master modules and at least one of the slave modules, and at least one filter Sj,jε[[1,n]] such as described previously. The storage means of each filter Sj store the two lists LRj and LWj already described.

Advantageously, this assembly comprises as many filters positioned as slave modules, each filter being inserted between the bus B and each slave module, as illustrated in FIG. 4. Such an assembly is therefore entirely protected from any unauthorised request to any slave module.

The invention finally relates to a system on chip comprising at least one assembly such as described previously.

1. A access-filtering method in a system on chip comprising at least one master module (M1, . . . , Mi, . . . , Mk), at least one slave module (S1, . . . , Sj, . . . , Sn) and a bus (B), the bus (B) comprising at least one slave port (PS1, . . . , PSi, . . . , PSn), at least one master port (PS1, . . . , PSj, . . . , PSn) and interconnection means between at least one of the slave ports and at least one of the master ports, the method being characterized in that it comprises the following steps performed when an access request is routed from a master module (Mi) connected to a slave port (PSi) to a slave module (Sj) connected to a master port (PMj), by a control device arranged on the link between the master port (PMj) and the slave module (Sj):
interception (CATCH) of source information (INFO) before the slave module (Sj) receives the request,
search (SEARCH) of the source information (INFO) in at least one list (Lj) of access control to the slave module (Sj),
blockage (BLOCK) of the request such that the slave module (Sj) ignores the requested access, if the source information is not found in the at least one access control list (Lj).

2. The access-filtering method according to claim 1, wherein the source information (INFO) comprises a unique identifier (IDPSi) of the slave port (PSi) via which the request transits.

3. The access-filtering method according to claim 1, wherein the source information (INFO) comprises an identifier (IDMi) of the master module (Mi) having sent the request.

4. The access-filtering method according to claim 2, wherein the source information is the concatenation of the identifier (IDMi) of the master module (Mi) and of the unique identifier (IDPSi) of the slave port (PSi).

5. The access-filtering method according to claim 3, wherein the identifier (IDMi) of the master module (Mi) is associated with an emission context of the request by the master module (Mi).

6. The access-filtering method according to claim 1, wherein the search step is conducted in two access control lists to the slave module (Sj), one (LRj) containing authorised read source information and the other (LWj) containing authorised write source information.

7. The access-filtering method according to claim 1, wherein the communication protocol between the master port (PMj) and the slave module (Sj) is the AXI protocol and wherein the blockage step comprises positioning at zero of a signal sent to the slave module, the signal being AWVALID if the request is a write request, or ARVALID if the request is a read request.

8. The access-filtering method according to claim 1, wherein the communication protocol between the master port (PMj) and the slave module (Sj) is the AHB or AHB-lite protocol and wherein the blockage step comprises the positioning at zero of an HSEL signal sent to the slave module (Sj).

9. The access-filtering method according to claim 1, wherein the communication protocol between the master port (PMj) and the slave module (Sj) is the APB protocol and wherein the blockage step comprises the positioning at zero of a PSEL signal sent to the slave module (Sj).

10. The access-filtering method according to claim 1, comprising an additional sending step (ERR) of an exception message (EX) to an interruption controller after blockage of the request.

11. A device (F1, . . . , Fj, . . . , Fn) for access control to a slave module by means of an interconnection bus, comprising storage means and data-processing means for executing the filtering method according to claim 1.

12. An assembly comprising at least one master module (M1, . . . , Mi, . . . , Mk), at least one slave module (S1, . . . , Sj, . . . , Sn), a bus (B) ensuring interconnection between at least one of the master modules and at least one of the slave modules, and at least one access control device (F1, . . . , Fj, . . . , Fn) according to claim 11 connected to a master port (PM1, . . . , PMj, . . . , PMn) of the bus (B) and to one of the slave modules (S1, . . . , Sj, . . . , Sn).

13. The assembly according to claim 12, wherein the bus (B) is of AMBA type.

14. A system on chip comprising at least one assembly according to claim 12.
